(19) United States
(12) Patent Application Publication
(10) Pub. No.: US 2013/0019848 A1
(43) Pub. Date: Jan. 24, 2013

(54) EXHAUST GAS RECIRCULATION APPARATUS OF INTERNAL COMBUSTION ENGINE

(71) Applicant: Tomoyuki Noguchi, Nissin-shi (JP)

(72) Inventor: Tomoyuki Noguchi, Nissin-shi (JP)

(73) Assignee: TOYOTA JIDOSHA KABUSHIKI KAISHA, Toyota-shi, Aichi-ken (JP)

(21) Appl. No.: 13/639,705

(22) PCT Filed: Mar. 24, 2011
(86) PCT No.: PCT/JP2011/001732

§ 371 Date: Oct. 5, 2012

(51) Int. Cl. F02M 25/07

(52) U.S. Cl. 123/568.12

(57) ABSTRACT

Provided is an exhaust gas recirculation apparatus of an internal combustion engine which can suppress condensed water from being generated in an EGR pipe at the upstream side of an EGR cooler, and thus can suppress the an EGR pipe from being corroded. An EGR device comprises an EGR pipe formed with an EGR passage held in communication with an exhaust passage and an intake passage, an EGR shutoff valve provided on the EGR pipe to be close to the exhaust passage and operative to selectively take an opened state or a closed state to enable EGR gas to be shut off into the EGR passage in the closed state, an EGR valve provided on the EGR pipe closer to the intake passage than the EGR shutoff valve and operative to selectively take an opened state or a closed state to adjust the amount of the EGR gas flowing into the intake passage, an EGR cooler provided on the EGR pipe between the EGR shutoff valve and the EGR valve to cool the EGR gas flowing into the EGR passage, and a heating pipe 45 for heating the EGR pipe from the EGR shutoff valve to the EGR cooler.

### TECHNICAL FIELD

The present invention relates to an exhaust gas recirculation apparatus of an internal combustion engine.

### BACKGROUND ART

Up until now, there have been proposed an exhaust gas recirculation apparatus for recirculating exhaust gas burned in a combustion chamber to a intake passage as an EGR gas to reduce a fuel consumption amount of an internal combustion engine(for example see Patent Document 1).

The exhaust gas recirculation apparatus disclosed in the Patent Document 1 comprises an EGR passage for allowing part of the exhaust gas flowing in an exhaust passage to be recirculated to a intake passage, an EGR valve provided in the EGR passage to adjust the flow amount of the EGR gas to be recirculated in a intake passage, and an EGR cooler provided between the EGR valve and the exhaust passage to cool the EGR gas by heat exchange between the EGR gas and cooling water to be used for the internal combustion engine.

The exhaust gas recirculation apparatus thus constructed can realize the recirculation of the EGR gas to the intake passage from the exhaust passage in response to the operation state of the internal combustion engine by adjusting the flow amount of the EGR gas to be recirculated in the EGR passage by the EGR valve.

In the previously mentioned exhaust gas recirculation apparatus, the exhaust gas tends to flow into the EGR passage due to the pulsation of the exhaust gas even when the EGR valve is operated to be changed from its opened state to its closed state. For overcoming this problem, there has been proposed and known another exhaust gas recirculation apparatus which comprises a shutoff valve provided to prevent the EGR gas from flowing into the EGR passage from the exhaust passage (for example see Patent Document 2).

The exhaust gas recirculation apparatus disclosed in the Patent Document 2 is mounted on a vehicle provided with a turbocharger having a turbine arranged in an exhaust passage, and having a compressor arranged in a intake passage. The exhaust gas recirculation apparatus is further provided with a low pressure EGR passage for recirculating part of the exhaust gas downstream of the turbine to the intake passage upstream of the compressor.

The exhaust gas recirculation apparatus disclosed in the Patent Document 2 comprises a low pressure EGR passage held in communication with the intake passage and the exhaust passage to recirculate part of the exhaust gas from the internal combustion engine to the intake passage, an EGR cooler for cooling the EGR gas on the way to the low pressure EGR passage, an EGR valve provided at the downstream side of the EGR cooler to adjust the flow amount of the EGR gas when the EGR gas cooled by the EGR cooler is recirculated to the intake passage, a determination unit for determining whether condensed water generated by the EGR gas cooled by the EGR cooler is retained or not in the EGR cooler, and a shutoff valve for suppressing the EGR gas from flowing into the EGR cooler when the condensed water is judged to be retained in the EGR cooler and the EGR gas is not recirculated to the intake passage.

Here, the above EGR valve is adapted to adjust the passage cross-sectional area of the low pressure EGR passage and thereby to adjust the flow amount of the EGR gas flowing in the low pressure EGR passage. Further, the shutoff valve is different from the EGR valve and is designed to take either one of the fully opened state and the fully closed state.

The exhaust gas recirculation apparatus disclosed in the Patent Document 2 is constructed as previously mentioned, and thus can bring the shutoff valve into the fully closed state when the condensed water generated in the EGR cooler is easily retained under the fully closed state of the EGR valve, thereby making it possible to suppress the EGR gas from flowing into the EGR cooler.

Therefore, the exhaust gas recirculation apparatus can suppress the condensed water from being retained in the EGR cooler and thus can suppress the EGR cooler from being corroded.

### CITATION LIST

### Patent Literature

{PTL 1} Japanese Patent Application Publication No. 2009-228530

{PTL 2} Japanese Patent Application Publication No. 2007-303381

### SUMMARY OF INVENTION

### Technical Problem

The conventional exhaust gas recirculation apparatus previously mentioned is, however, not designed to suppress the condensed water from being generated in an EGR pipe forming the low pressure EGR at the upstream side of the EGR cooler, and thus does not pay consideration to suppress the EGR pipe from being corroded.

More specifically, the conventional exhaust gas recirculation apparatus previously mentioned is constructed to have the EGR valve in the fully closed state and to have the shutoff valve also in the fully closed state when the internal combustion engine is in the warm-up state at the low temperature of the cooling water, thereby making it impossible to cause the EGR gas to raise the temperature of the ERG pipe. When the EGR valve is changed from the fully closed state to the fully opened state under these conditions, the shutoff valve is changed to the fully opened state from the fully closed state, so that there is a possibility that the EGR gas flowing into the low pressure EGR passage from the exhaust passage is cooled by the EGR pipe, thereby generating the condensed water in the low pressure EGR passage. The condensed water once generated in the EGR pipe possibly causes the EGR pipe to be corroded, resulting from the fact that the above condensed water is strongly oxidized by a sulfur component in the fuel, or otherwise contains a Cl component as chloride ion in the fuel.

Further, the conventional exhaust gas recirculation apparatus previously mentioned is constructed to have the shutoff valve maintained in the closed state when the EGR valve is changed from the opened state to the closed state, irrespective of the warm-up state, so that the low pressure EGR passage comes to be in a state having the EGR gas flow therein. At this time, there is a possibility that the condensed water is generated in the low pressure EGR passage when the temperature of the EGR pipe is dropped to the vicinity of the dew point temperature. Especially, a hybrid vehicle constructed to have an engine operated in a repeated intermittent mode occasionally causes condensed water to be generated when the engine is stopped. When a vehicle other than such a hybrid vehicle is changed from its usual operation state to its idle operation state, the EGR valve is changed to the fully closed state, thereby causing the condensed water to possibly be generated.

It is therefore an object of the present invention to solve the previously mentioned problems and to provide an exhaust gas recirculation apparatus of an internal combustion engine which can suppress the condensed water from being generated in the EGR pipe at the upstream side of the EGR cooler to suppress the EGR pipe from being corroded.

### Solution to Problem

To achieve the above object of the present invention, the exhaust gas recirculation apparatus of the internal combustion engine according to the present invention for recirculating part of exhaust gas discharged into an exhaust passage from an internal combustion engine to an intake passage as an EGR gas comprises: (1)

an EGR pipe formed therein with an EGR passage held in communication with the exhaust passage and the intake passage,

a first valve provided in the EGR pipe in the vicinity of the exhaust passage and operative to take an opened state and a closed state, the first valve being operative to shut off the EGR gas from being flowing into the EGR passage when the first valve takes the closed state,

a second valve provided in the EGR pipe at a position closer to the intake passage than the first valve and operative to take an opened state and a closed state to adjust the amount of the EGR gas flow into the intake passage, an EGR cooler provided in the EGR pipe between the first valve and the second valve to cool the EGR gas flowing into the EGR passage, and a heating unit for heating the EGR pipe from the first valve to the EGR cooler.

By the construction set forth in the above definition, the EGR pipe from the first valve to the EGR cooler can be heated, so that the temperature of the EGR pipe can be suppressed from being lowered to the vicinity of the dew point temperature during the operation of the engine. This makes it possible to suppress the condensed water being generated in the EGR pipe at the upstream side of the EGR cooler and thus to suppress the EGR pipe from being corroded.

In the exhaust gas recirculation apparatus of the internal combustion engine set forth in the above definition (1), (2) the heating unit is adapted to heat the EGR pipe by the heat exchange with the cooling water of the internal combustion engine.

By the construction set forth in the above definition, the exhaust gas recirculation apparatus is constructed to heat the EGR pipe by the heat exchange of the cooling water of the internal combustion engine, so that the EGR pipe can be heated without any other heating source, thereby making it possible to reduce the production cost of the exhaust gas recirculation apparatus from the conventional apparatus required to have other heating source. Further, the EGR gas can be cooled by the cooling water supplied to the heating unit after the warm-up operation of the internal combustion engine, so that the cooling operation of the EGR gas by the EGR cooler can be shouldered by the heating unit. This means that the EGR cooler can be simplified in construction, thereby making it possible to realize the reduction of the production cost of the exhaust gas recirculation apparatus.

In the exhaust gas recirculation apparatus of the internal combustion engine set forth in the above definition (1) or (2), (3) the heating unit is disposed outside of the EGR pipe to have the heating unit and the EGR pipe be in the form of a double pipe structure.

By the construction set forth in the above definition, the heating unit can be realized to be simplified in construction, thereby making it possible to reduce the production cost of the exhaust gas recirculation apparatus as well as to facilitate the installation of the exhaust gas recirculation apparatus onto the vehicle.

The exhaust gas recirculation apparatus of the internal combustion engine set forth in any one of the above definitions (1) to (3) further comprises, (4) a water temperature sensor for detecting the temperature of the cooling water of the internal combustion engine, and a control unit for controlling the first valve to have the first valve changed to take the opened state from the closed state, and for controlling the opening degree of the second valve when the temperature of the cooling water detected by the water temperature sensor is not lower than a threshold value.

By the construction set forth in the above definition, the control unit is operative to control the first valve to have the first valve transferred to the opened state from the closed state when the temperature of the cooling water is not lower than a threshold value and to control the opening degree of the second valve, so that the control of the exhaust gas recirculation amount can suitably be executed in response to the combustion state of the internal combustion engine. Further, the EGR gas can be introduced into the EGR passage in the state in which the warm-up operation is finished, thereby making it possible to prevent the temperature of the EGR gas from being lowered to the dew point temperature or less and thus to suppress the condensed water from being generated in the EGR pipe and the EGR cooler.

The exhaust gas recirculation apparatus of the internal combustion engine set forth in the above definition (4) further comprises (5) an outside air temperature sensor for detecting an outside air temperature, and in which the control unit is adapted to set the threshold value in response to the outside air temperature detected by the outside air temperature sensor.

By the construction set forth in the above definition, the control unit can set the conditions to have the first valve and the second valve transferred to the opened states from the closed states, respectively, in response to the temperature of the outside air, thereby making it possible to execute the controls of the first valve and the second vale in response to the temperature of the outside air. Therefore, the second valve being constituted by the EGR valve enables the EGR valve to be controlled in response to the temperature environment of the EGR pipe, thereby making it possible to suitably suppress the condensed water from being generated.

In the exhaust gas recirculation apparatus of the internal combustion engine set forth in the above definition (1), (6) the heating unit is constituted by an exhaust manifold for introducing the exhaust gas from the internal combustion engine to the exhaust passage, and the EGR pipe is heated by radiation heat from the heating unit.

By the construction set forth in the above definition, the EGR pipe can be heated by the radiation heat of the exhaust manifold, thereby making it possible to realize the exhaust gas recirculation apparatus simplified in construction and to reduce the production cost of the exhaust gas recirculation apparatus.

### Advantageous Effects of Invention

The exhaust gas recirculation apparatus according to the present invention can suppress the condensed water from being generated in the EGR pipe at the upstream side of the EGR cooler, thereby making it possible to suppress the EGR pipe from being corroded.

### BRIEF DESCRIPTION OF DRAWINGS

FIG. 1 is a schematic construction view of an exhaust gas recirculation apparatus of an internal combustion engine according to the first embodiment of the present invention.

FIG. 2 is a perspective view showing an EGR cooler and an EGR valve according to the first embodiment of the present invention.

FIG. 3 is a block diagram showing the exhaust gas recirculation apparatus and its peripheral constitutional portions according to the first embodiment of the present invention.

FIG. 4 is a schematic construction view showing the construction of a cooling water circuit according to the first embodiment of the present invention.

FIG. 5 is a flow chart for explaining an EGR control according to the first embodiment of the present invention.

FIG. 6 is a schematic construction view of an exhaust gas recirculation apparatus of an internal combustion engine according to the second embodiment of the present invention.

### DESCRIPTION OF EMBODIMENTS

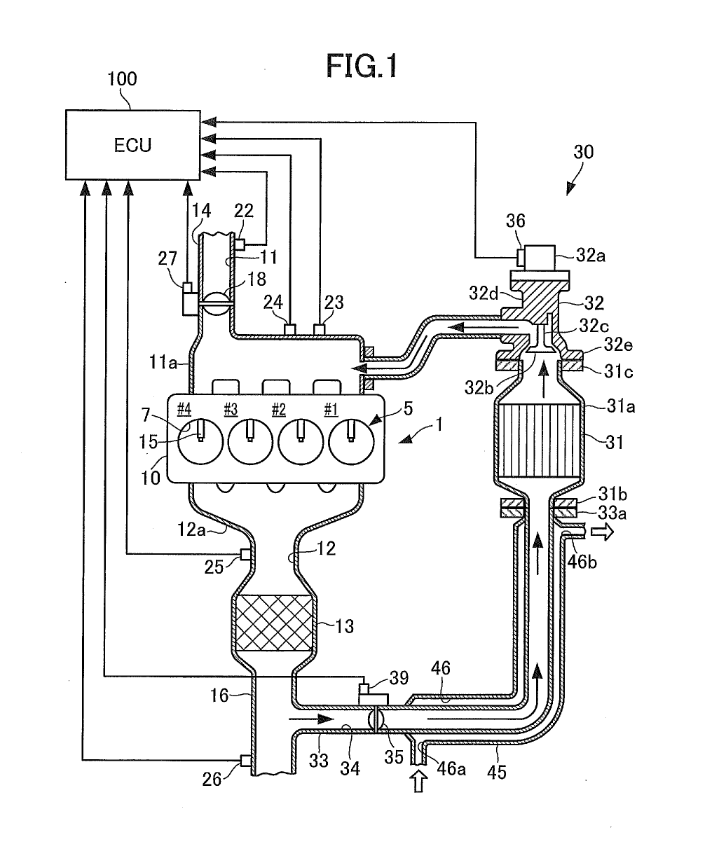

The exhaust gas recirculation apparatus of the internal combustion engine according to the first embodiment of the present invention will be described hereinafter with reference to FIGS. 1 to 5. The present embodiment of the present invention will be explained about an exhaust gas recirculation apparatus which is applied to a vehicle having a four-cylinder gasoline engine mounted thereon.

Firstly, the construction of this embodiment will be explained hereinafter.

As shown in FIG. 1, an engine 1 is provided with a cylinder head 10, and a cylinder block not shown, the cylinder head 10 and the cylinder block forming together four cylinders 5. These cylinders form combustion chambers 7, respectively, with pistons received therein. The cylinder head 10 is formed with suction ports for introducing air into the cylinders 5 and exhaust ports for discharging exhaust gas from the cylinders 5.

Each of the suction ports has an injector formed therein to inject fuel which is mixed with air to be introduced into the combustion chamber 7. The cylinder head 10 has ignition plugs 15 each of which serves to ignite the fuel/air mixture introduced into each of the combustion chambers 7. The ignition plugs 15 have respective ignition timings adapted to be controlled by an Electric Control Unit (hereinafter simply referred to as “ECU”) 100 which will hereinafter be described in detail.

The injectors are each constructed by an electromagnet valve which is adapted to be opened to inject the fuel to the suction port of each of the cylinders 5 when the electromagnet valve is energized with a predetermined electric pressure by the ECU 100.

The engine 1 further has an intake manifold 11 a connected to the cylinder head 10 and having part of an intake passage 11 formed therein. The intake passage 11 is partly formed in an intake pipe 14 to accommodate therein an air cleaner not shown and an air flow meter 22 in this order from the upstream side to the downstream side of the passage 11. The intake passage 11 further has a throttle valve 18 disposed at the upstream side of the intake manifold 11a to adjust the amount of intake air. The intake manifold 11a is provided with an intake air temperature sensor 23 and a pressure sensor 24.

The throttle valve 18 is constituted by an electrically controlled type of opening and closing valve which is capable of steplessly adjusting the opening degree thereof, and is adapted to throttle the passage area of the intake air to adjust the supply amount of the intake air under the predetermined condition. The ECU 100 is operative to control a throttle motor mounted on the throttle valve 18 to adjust the opening degree of the throttle valve 18.

The engine 1 further has an exhaust manifold 12a connected with the cylinder head 10 and forming part of an exhaust passage 12. The exhaust passage 12 has a catalyst device 13 mounted thereon and constituted for example by a three-way catalyst. The exhaust passage 12 at the upstream side of the catalyst device 13 has an A/F sensor 25 mounted thereon. The exhaust passage 12 at the downstream side of the catalyst device 13 has an exhaust gas temperature sensor 26 mounted thereon. The A/F sensor 25 and the temperature sensor 26 are operative to output respective signals to be inputted to the ECU 100.

The engine 1 is further provided with an EGR device 30. The EGR device 30 functions to recirculate part of the exhaust gas flowing in the exhaust passage 12 to the intake passage 11 to supply the exhaust gas as an EGR gas to the combustion chamber 7 of each of the cylinders 5, so that the combustion temperature in the combustion chamber 7 can be lowered and thereby can reduce the amount of NOx to be generated. Further, the pumping loss can be reduced to enhance the fuel consumption of the vehicle.

The EGR device 30 is constructed to connect the intake manifold 11a and the exhaust pipe 16, and is provided with an EGR pipe 33 formed therein with an EGR passage 34. The EGR pipe 33 is provided with an EGR cooler 31 for cooling the EGR gas passing through the EGR passage 34, and an EGR valve 32.

The intake manifold 11a has a delivery pipe, not shown, made of a stainless steel mounted thereon. The delivery pipe is constructed by a tubular member having the EGR passage 34 and the intake manifold 11a held in communication with each other.

The EGR device 30 further has a heating pipe 45 for heating the EGR pipe 33 between an EGR shutoff valve 35 and the EGR cooler 31 which will become apparent as the description proceeds. The heating pipe 45 is made of a metal material such as stainless steel and the like. The heating pipe 45 is disposed outside of the EGR pipe 33 to have the heating pipe 45 and the EGR pipe 33 be in the form of a double pipe structure.

The outer peripheral surface of the EGR pipe 33 and the inner peripheral surface of the heating pipe 45 forms in combination a cooling water passage 46. The cooling water passage 46 forms part of a third passage 49 of a cooling water circuit 40 which will also be described hereinafter. The cooling water of the engine 1 is supplied into the heating pipe 45 through an inlet port 46a, while being discharged from the heating pipe 45 through an outlet port 46b. The above heating pipe 45 according to the present embodiment constitutes a heating unit defined in the present invention.

The part of the EGR pipe 33 in the vicinity of the exhaust pipe 16 is heated by the exhaust gas maintained at a high temperature and flowing in the exhaust passage 12. If the heating pipe 45 outside of the EGR pipe 33 is disposed in the vicinity of the exhaust pipe 16, the heating up process is rather delayed in the warm-up operation of the engine 1 since the temperature of the cooling water is lower than that of the exhaust gas. It is therefore suitable that the heating pipe 45 be disposed at the position having a larger heating effect by the cooling water than by the exhaust gas flowing in the exhaust passage 12 during the warm-up operation of the engine 1. For this reason, the upstream side end portion of the heating pipe 45 is positioned to be spaced apart by a predetermined distance from the joint portion of the exhaust pipe 16 and the EGR pipe 33.

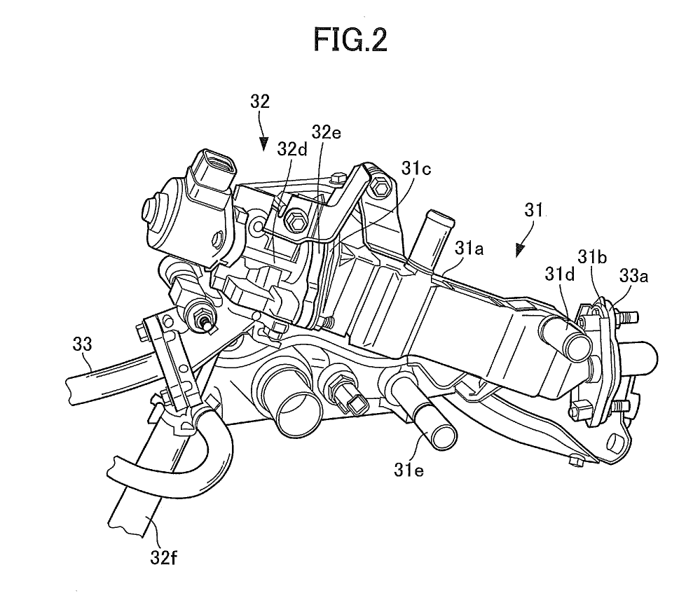

The EGR cooler 31 is formed mainly of a stainless steel, and comprises a case 31 a, and a cooling water pipe wound around the outer peripheral portion of the passage of the EGR gas in the case 31a as shown in FIGS. 1 and 2. The EGR gas supplied from the EGR passage 34 is cooled by the heat exchange with the cooling water flowing in the cooling water pipe when the EGR gas passes through the passage of the EGR gas in the case 31a, and then introduced to the downstream side of EGR passage 34. The EGR cooler 31 is connected with an inlet pipe 31d for introducing the cooling water passed through the engine 1, and with an outlet pipe 31e connected with an inlet pipe, not shown, of the EGR valve 32, so that the cooling water can flow into the cooling water pipe from the inlet pipe 31d, and can be discharged from the outlet pipe 31e.

The EGR valve 32 is provided with an EGR valve driving unit 32a, and a shaft 32c. The EGR valve driving unit 32a is accommodated in the EGR valve 32, while the shaft 32c has a base end portion slidably received in the EGR valve driving unit 32a, and a forward end portion formed with a valve disc 32b for opening and closing the EGR passage 34. The EGR valve driving unit 32a is constituted by for example a step motor and a DC motor. The ECU 100 is adapted to energize and control the EGR valve driving unit 32a to have the shaft 32c driven to axially be reciprocated under the influence of the electromagnetic force and a coil spring not shown, and thus to have the valve disc 32b open and close the EGR passage 34. Here, the EGR valve 32 constitutes a second valve defined in the present invention.

The EGR valve 32 is made mainly of aluminum, stainless steel and other metal materials. The EGR valve 32 has a case 32d formed with an EGR valve passage surrounding the shaft 32c. The EGR valve passage has an upstream side end portion connected with an inlet pipe through which the cooling water discharged from the outlet pipe 31e of the EGR cooler 31 is introduced into the EGR valve passage. The outlet pipe 32f is connected with a downstream side end portion of the EGR valve passage. The shaft 32c and the valve disc 32b to be exposed to the high temperature exhaust gas are cooled by the cooling water flowing in the EGR valve passage, and the EGR valve driving unit 32a is also cooled by the cooling water flowing in the EGR valve passage.

The ECU 100 is adapted to adjust the opening degree of the EGR valve driving unit 32 and thereby to adjust the amount of the EGR gas, i.e., the recirculation amount of the exhaust gas introduced into the intake manifold 11 a from the exhaust manifold 12a, resulting from the exhaust passage 12 and the intake passage 11 being brought into communication with each other.

The case 31a of the EGR cooler 31 is made of a metal having heat conductivity, and has an upstream side end portion and a downstream end portion formed with fastening portions 31b and 31c, respectively. The case 32d of the EGR valve 32 is also made of a metal having heat conductivity, and has an upstream side end portion formed with a fastening portion 32e.

The EGR cooler 31 and the EGR valve 32 is, as shown FIG. 2, directly connected with each other by the fastening portions 31c, 32e, with no EGR pipe intervening between the EGR cooler 31 and the EGR valve 32. The fastening portions 31c, 32e are respectively constructed by for example hermetically sealing flanges which are fastened to each other by means of bolts and other fastening devices, or alternatively secured to each other by a known securing method such as a welding and the like. The heat can be conducted between the EGR cooler 31 and the EGR valve 32 by way of the fastening portions 31c, 32e.

The fastening portion 31b of the EGR cooler 31 is connected with a fastening portion 33a forming part of the EGR pipe 33. The fastening portions 31b, 33a are respectively constructed by for example hermetically connecting flanges which are fastened to each other by means of bolts and other fastening devices, or alternatively secured to each other by a known securing method such as a welding and the like.

The EGR device according to the present embodiment is further provided with an EGR shutoff valve 35 at the upstream side of the EGR cooler 31. The EGR shutoff valve 35 is made of a metal such as aluminum, stainless steel and the like, and is constructed by a diaphragm valve or an electromagnet valve or the like which is operative to take an opened state in which it is fully opened, and a closed state in which it is fully closed. The EGR shutoff valve 35 is designed to shut off the EGR passage 34 to prevent the exhaust gas discharged to the exhaust manifold 12a from flowing into the EGR device 30 under the predetermined operation condition as will be described hereinafter. The EGR shutoff valve 35 may be constructed by a shutoff valve which is capable of having a desired state between the fully opened state and the fully closed state. Here, the above EGR shutoff valve 35 according to the present embodiment constitutes a first valve.

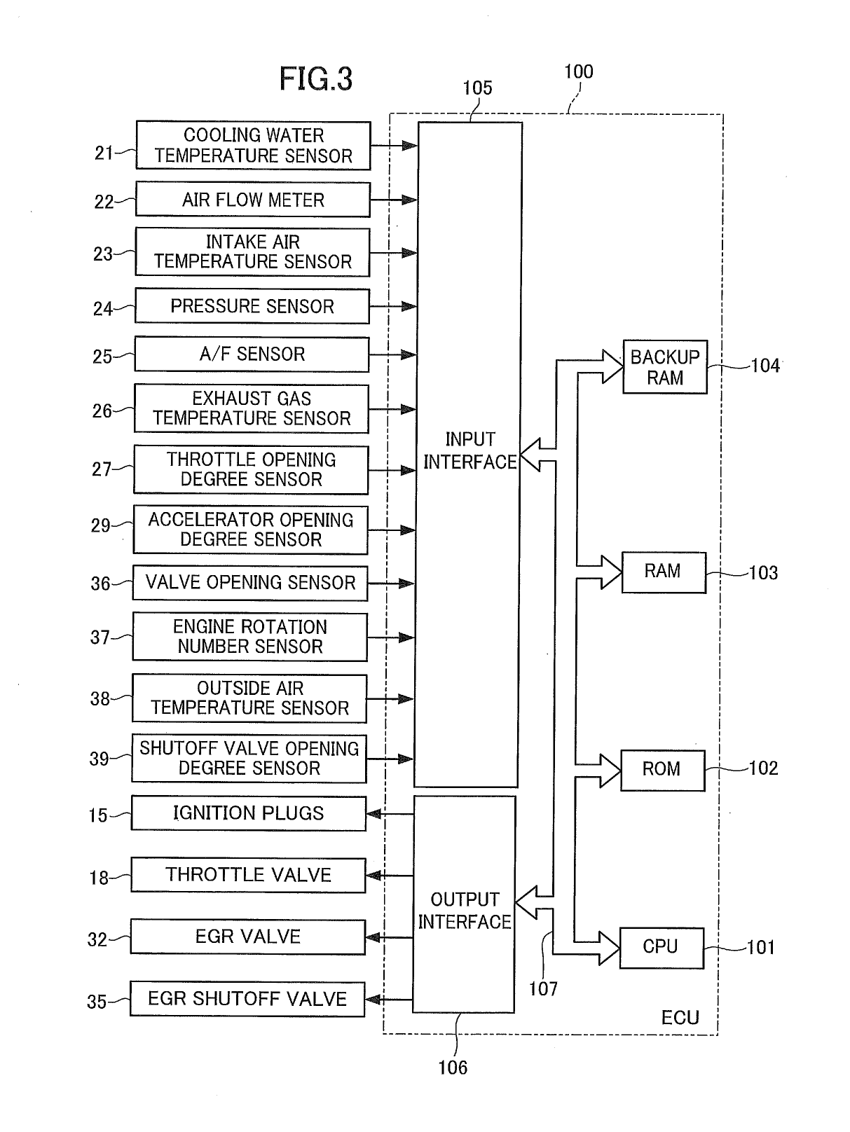

As shown in FIGS. 1 and 3, the engine 1 has various portions on which are provided a cooling water temperature sensor 21, an exhaust gas temperature sensor 26, an accelerator opening degree sensor 29, a throttle opening degree sensor 27, a valve opening degree sensor 36, and a shutoff valve opening degree sensor 39 other than the previously mention sensors. The accelerator opening degree sensor 29 is adapted to output a detection signal indicative of the depression amount of an acceleration pedal, while the throttle opening degree sensor 27 is adapted to output a detection signal indicative of the opening degree of the throttle valve 18. The vehicle having the engine 1 mounted thereon is provided with an engine rotation number sensor 37 and an outside air temperature sensor 38. The engine rotation number sensor 37 is adapted to detect the rotation number of the crank shaft of the engine 1 and to output a detection signal indicative of the engine rotation number sensor.

The cooling water temperature sensor 21 is mounted on a water jacket formed in the cylinder block of the engine 1 to output a detection signal indicative of a cooling water temperature THW of the engine 1. The air flow meter 22 is disposed at the upstream side of the throttle valve 18 of the intake passage 11 to output a detection signal indicative of the intake air amount of air flowing in the intake passage 11 to the ECU 100. The intake air temperature sensor 23 is disposed in the intake manifold 11 a to output a detection signal indicative of the temperature of the intake air in the intake manifold 11a to the ECU 100. The pressure sensor 24 is disposed in the intake manifold 11a to output a detection signal indicative of the pressure of the intake air in the intake manifold 11a to the ECU 100.

The A/F sensor 25 is disposed in the exhaust passage 12 at the upstream side of the catalyst device 13 to output a detection signal indicative of the oxygen concentration in the exhaust gas (exhaust A/F) of the exhaust passage 12 to the ECU 100. The exhaust gas temperature sensor 26 is disposed in the exhaust passage 12 at the downstream side of the catalyst device 13 to output a detection signal indicative of the temperature of the exhaust gas in the exhaust passage 12 to the ECU 100. The valve opening degree sensor 36 is adapted to output a detection signal indicative of the opening degree of the EGR valve 32 to the ECU 100. The outside air temperature sensor 38 is adapted to output a detection signal indicative of the temperature of the outside air to the ECU 100. The shutoff valve opening degree sensor 39 is adapted to output a detection signal indicative of the opening degree of the EGR shutoff valve 35 to the ECU 100.

The ECU 100 is mounted on the vehicle having the engine 1 mounted thereon, and comprises a central processing unit (hereinafter simply referred to as “CPU”) 101, a read only memory (hereinafter simply referred to as “ROM”) 102, a random access memory (hereinafter simply referred to as “RAM”) 103, and a backup RAM 104. The previously mentioned ECU 100 according to the present embodiment constitutes part of the exhaust gas recirculation apparatus according to the present invention.

The ROM 102 is adapted to memorize various kinds of programs including a program for executing the EGR control to adjust the exhaust gas circulation amount, and a control program for controlling the fuel injection amount to the cylinder 5, and a map referred at the time of executing the above control programs. The CPU 101 is adapted to execute various kinds of arithmetic processings based on the various kinds of control programs and the map memorized in the ROM 102. Further, the RAM 103 is adapted to temporarily memorize the results of arithmetic processings, and the data and the like inputted from the above sensors. The backup RAM 104 is constituted by a non-volatile memory to memorize the data and the like to be stored for example at the time of stopping the engine 1.

The CPU 101, the ROM 102, the RAM 103, and the backup RAM 104 are connected with one another through a bus 107, and connected with an input interface 105 and an output interface 106.

The input interface 105 is connected with the cooling water temperature sensor 21, the air flow meter 22, the intake air temperature sensor 23, the pressure sensor 24, the A/F sensor 25, the exhaust gas temperature sensor 26, the accelerator opening degree sensor 29, the throttle opening degree sensor 27, the valve opening degree sensor 36, the engine rotation number sensor 37, the outside air temperature sensor 38, and the shutoff valve opening degree sensor 39. As previously mentioned, the accelerator opening degree sensor 29 is adapted to output a detection signal indicative of the depression amount of the acceleration pedal, while the throttle opening degree sensor 27 is adapted to output the detection signal indicative of the opening degree of the throttle valve 18. The engine rotation number sensor 37 is adapted to detect the rotation number of the crank shaft of the engine 1 and to output the detection signal indicative of the engine rotation number sensor.

The output interface 106 is connected with the ignition plug 15, the throttle valve 18, the EGR valve 32, the EGR shutoff valve 35 and the injector not shown.

The ECU 100 is adapted to execute various kinds of controls of the engine 1 including the EGR control and the fuel injection amount control based on the signals outputted by the above sensors.

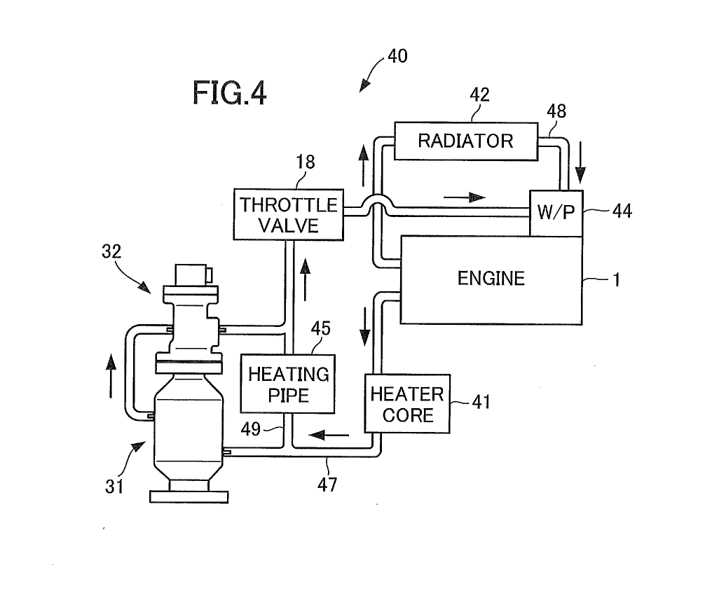

FIG. 4 is a schematic construction view showing the construction of a cooling water circuit 40 for supplying the cooling water to the EGR device 30 according to the present embodiment. The cooling water circuit 40 has a first passage 47 and a second passage 48. The first passage 47 is adapted to supply the cooling water discharged from a water pump 44 to the engine 1, a heater core 41, the EGR cooler 31, the EGR valve 32 and the throttle valve 18 in this order and for returning the cooling water to the water pump 44. The second passage 48 is bifurcated from the first passage 47 by a three-way valve, not shown, provided at the downstream side of the cylinder head 10 constituting part of the engine 1 to supply part of the cooling water flowing out of engine 1 to a radiator 42, and for returning the cooling water to the water pump 44.

The cooling water circuit 40 has a third passage 49 bifurcated from the first passage 47 at the downstream side of the heater core 41, and merged with the first passage 47 at the upstream side of the throttle valve 18 by way of the heating pipe 45.

The cooling water recirculated through the first passage 47 is heated by the heat exchange with the cylinder block and the cylinder head 10 forming part of the engine 1. The part of the cooling water is cooled by the heat exchange with the heater core 41 and then supplied to the EGR cooler 31. The remaining part of the cooling water is heat exchanged with the heater core 41, and then flows into the third passage 49, and the heating pipe 45 where the cooling water is heat exchanged with the EGR pipe 33. The cooling water is merged with the cooling water recirculated through the first passage 47 at the upstream side of the throttle valve 18.

On the other hand, the cooling water recirculated through the second passage 48 is supplied to the radiator 42 where the cooling water is cooled by the heat exchange with the outside air after separated from the first passage 47 by a thermostat, not shown, provided at the downstream side of the cylinder head 10.

The thermostat is constructed to shut off the passage between the radiator 42 and the water pump 44 when the temperature THW of the cooling water of the engine 1 at the warm-up operation time and at the travelling time in the cold regions is lower than the temperature of the cooling water of the engine 1 operated at the usual travelling time of the vehicle. Further, the thermostat is constructed to gradually open the passage between the radiator 42 and the water pump 44 in response to the raised temperature THW of the cooling water to increase the percentage of the amount of the cooling water recirculated in the second passage with respect to the amount of the cooling water recirculated in the first passage 47.

The ECU 100 constituting the control device according to the present embodiment of the present invention is operative to change the EGR shutoff valve 35 to take the closed state based on the signal inputted from the cooling water temperature sensor 21 if the ECU 100 determines that the temperature THW of the cooling water is less than the predetermined value THWth.

The predetermined value THWth is set to a temperature of example 70° C. at which the EGR control starts after the warm-up operation of the engine 1 is finished. Here, the dew point temperature of the exhaust gas is 60° C. or less. The condensed water can be suppressed from being generated in the EGR cooler 31 even when the exhaust gas is supplied to the EGR device 30 at the time of the temperature THW of the cooling water being 70° C. or more. The condensed water can also be suppressed from being generated in the EGR valve 32 since the cooling water is supplied to the EGR valve 32.

The EGR device 30 according to the present embodiment is different from the conventional EGR device, but has no EGR pipe between the EGR cooler 31 and the EGR valve 32, where such kind of EGR pipe can not be heated by the cooling water. In contrast, the conventional EGR device occasionally generates the condensed water in the EGR pipe due to the fact the EGR pipe is not fully heated when the temperature THW of the cooling water reaches the predetermined value THWth and the EGR shutoff valve 35 is changed from the fully closed state to the fully opened state. The EGR device 30 according to the present embodiment is constructed to generate no condensed water with the EGR gas cooled between the EGR cooler 31 and the EGR valve 32 when the warm-up operation is finished and the EGR shutoff valve 35 is changed to the opened state.

The ECU 100 is operative to execute no EGR control, and to have the EGR shutoff valve 35 changed to the fully closed state at the time of the EGR valve 32 being changed to the fully closed state, thereby preventing the pulsated exhaust gas from flowing into the EGR device 30 at the EGR valve 32 being in the fully closed state. In this way, if the EGR valve 32 takes the fully closed state, the EGR shutoff valve 35 also takes the fully closed state, while the EGR valve 32 takes the fully opened state, viz., takes a state other than the fully closed state, the EGR shutoff valve 35 is adapted to take the fully opened state.

The ECU 100 is operative to change the EGR shutoff valve 35 to the fully opened state and to start the EGR control when judging that the temperature THW of the cooling water is higher than 70° C. based on the signal inputted from the cooling water temperature sensor 21.

The ECU 100 is operative to execute the EGR control to control the EGR valve 32 and to adjust the flow amount of the EGR gas when judging that the warm-up operation is finished to have the EGR shutoff valve 35 changed to the opened state. The ECU 100 is operative to memorize at the EGR valve 32 the opening degree map relating the engine rotation number and the engine load with the opening degree of the EGR valve 32. The ECU 100 is adapted to set the opening degree of the EGR valve 32 with reference to the opening map memorized in the ROM 102 when acquiring the information about the engine load to be obtained from the engine rotation number detected by the engine rotation number sensor 37 and the amount of the intake air detected by the air flow meter 22.

The ECU 100 is adapted to preliminarily memorize in the ROM 102 the engine load map relating the amount of the intake air with the engine load. The relationship between the amount of the intake air and the engine load can be obtained by the experimental measurement preliminarily carried out. Further the engine load can be calculated by a known method such as for example a method of calculating from the fuel injection amount in the engine 1 in place of the intake air amount.

Next, the operation of the exhaust gas circulation apparatus according to the embodiment of the present invention will be described hereinafter.

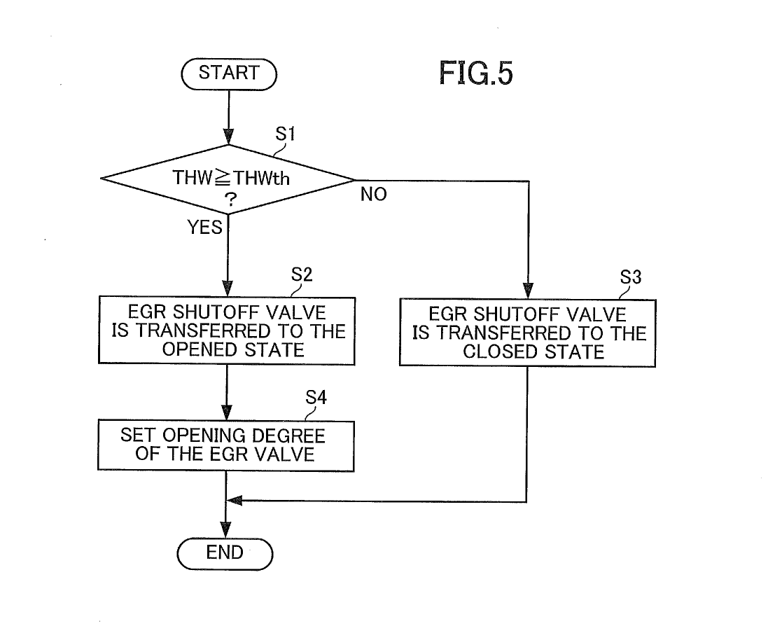

FIG. 5 is a flow chart for explaining the EGR control according to the embodiment of the present invention. The following processing is executed at a predetermined time interval by the CPU 101 constituting the ECU 100, and realizes a program that can be processed by the CPU 101.

The ECU 100 is operated to judge whether or not the temperature THW of the cooling water is lower than the predetermined value THWth based on the signal acquired from the cooling water temperature sensor 21 (Step S1).

When the ECU 100 judges that the temperature THW of the cooling water is not lower than the predetermined value THWth (“YES” in Step S1), the EGR shutoff valve 35 is transferred from the closed state to the opened state (Step S2) due to the fact that no condensed water is generated in the EGR cooler 31 and the EGR valve 32 even when the exhaust gas flows into the EGR passage 34 as the EGR gas. At this time, there is also no condensed water in the EGR pipe 33 since the EGR pipe 33 is heated by the cooling water supplied to the cooling water passage 46.

When, on the other hand, the ECU 100 judges that the temperature THW of the cooling water does not reach the predetermined value THWth (“NO” in Step S1), the EGR shutoff valve 35 is transferred to the closed state from the opened state (Step S3), and then moves to “ RETURN” in order to prevent the condensed water from being generated in the EGR cooler 31 or the EGR valve 32 as a result of the exhaust gas flowing into the EGR passage 34 and falling into being the dew point temperature or less. At this time, the cooling water heated by the engine 1 is supplied to the cooling passage 46, so that the EGR pipe 33 can be heated by the heat of the cooling water in the cooling passage 46 even if the exhaust gas maintained at a high temperature is not introduced into the EGR pipe 33.

If the EGR shutoff valve 35 is held in the closed state in Step S3, the ECU 100 is operated to have the EGR shutoff valve 35 continue to take the closed state.

In Step S4, the ECU 100 is operated to execute the control of the EGR valve 32 in response to the combustion state of the engine 1. More concretely, the ECU 100 is operated to acquire the signal indicative of the engine rotation number from the engine rotation number sensor 37 as well as to calculate the engine load based on the signal inputted from the air flow meter 22 and the engine load map memorized in the ROM 102. The ECU 100 is operated to set the opening degree of the EGR valve 32 based on the opening degree map memorized in the ROM 102.

As previously mentioned, the exhaust gas recirculation apparatus of the internal combustion engine according to the first embodiment of the present invention can heat the EGR pipe 33 from the EGR shutoff valve 35 to the EGR cooler 31, thereby making it possible to suppress the temperature of the EGR pipe 33 from being lowered to the vicinity of the dew point temperature during the operation of the engine 1. It is therefore possible to suppress the condensed water from being generated in the EGR pipe 33 at the upstream side of the EGR cooler 31, and thus to suppress the EGR pipe 33 from being corroded.

Further, the EGR device 30 can heat the EGR pipe 33 by the heat exchange with the cooling water of the engine 1, thereby making it possible to realize the heating-up of the EGR pipe 33 with no other heat source to be provided and thus to reduce the cost of producing the exhaust gas recirculation apparatus as compared with the conventional exhaust gas recirculation apparatus which needs other heating source to be provided.

After the warm-up operation of the engine 1 is finished, the EGR gas can be cooled by the cooling water supplied to the heating pipe 45, thereby making it possible to have the heating pipe 45 shoulder the cooling of the EGR gas by the EGR cooler 31. This makes it possible to allow the EGR cooler 31 to have a simple construction, and to reduce the cost of the exhaust gas recirculation apparatus.

The heating pipe 45 and the EGR pipe 33 being formed in the double pipe structure makes it possible to realize the simple construction of the heating pipe 45 and to reduce the cost of the exhaust gas recirculation apparatus, thereby making it possible to facilitate the installation of the EGR device 30 to the vehicle.

The ECU 100 is operated to control the EGR shutoff valve 35 to transfer from the closed state to the opened state and to control the opening degree of the EGR valve 32 when the temperature of the cooling water is higher than the threshold value, so that the recirculation amount of the exhaust gas can adequately be controlled in response to the combustion state of the engine 1. The EGR gas can be introduced into the EGR passage 34 in the state in which the warm-up operation of the engine 1 is finished, so that the temperature of the EGR gas is by no means lowered to the dew point temperature or less, thereby suppressing the condensed water from being generated in the EGR pipe 33 and the EGR cooler 31.

The above explanation has been directed to the case in which the ECU 100 is operated to execute the EGR control when the temperature THW of the cooling water is not lower than the predetermined value THWth. However, the temperature of the EGR pipe 33 at the upstream side of the heating pipe 45 is varied depending upon the outside air temperature. For this reason, the ECU 100 may be operative to correct the predetermined value THWth in response to the outside air temperature.

When the outside air temperature is for example relatively high, the temperature of the EGR pipe 33 at the upstream side of the heating pipe 45 becomes heightened. For this reason, even in the state that the temperature of the cooling water is lower than the predetermined value THWth, the temperature of the EGR pipe 33 becomes higher than the due point temperature of the EGR gas. When, on the other hand, the outside air temperature is relatively low, the temperature of the EGR pipe 33 at the upstream side of the heating pipe 45 becomes lowered. For this reason, in order to raise the temperature of the EGR pipe 33, it is required to raise the temperature of the cooling water to the predetermined value THWth or more.

It is therefore understood that the ECU 100 is operative to correct the predetermined value THWth to the higher level in response to the higher outside air temperature, and to correct the predetermined value THWth to the lower level in response to the lower outside air temperature based on the signal inputted from the outside air temperature sensor 38. Further, the ECU 100 is operative to correct the predetermined value THWth in the range higher than the dew point temperature of the EGR gas after the correction of the predetermined value THWth. The ECU 100 according to the present embodiment constitutes a control unit defined in the present invention.

The ECU 100 therefore can set the condition in which the EGR valve 32 and the EGR shutoff valve 35 are transferred from the opened state to the closed state in response to the outside air temperature, so that the control of the EGR valve 32 and the EGR shutoff valve 35 can be executed in response to the outside air temperature.

Therefore, the ECU 100 can control the EGR valve 32 in response to the temperature environment of the EGR pipe 33, and can suitably suppress the condensed water from being generated.

The above explanation has been directed to the case that the cooling water to be supplied to the heating pipe 45 is supplied from the heater core 41, however, the present invention is not limited to this case, but may be applied to the case that the cooling water is supplied to the heating pipe 45 from the engine 1 without passing through the heater core 41. In this case, the cooling water is supplied to the heating pipe 45 without the temperature of the cooling water being lowered by the heat exchange in the heating core 41, thereby making it possible to heat the heating pipe 45 in a shorter time.

While the above explanation has been directed to the case that the EGR pipe 33 is heated by the heating pipe 45; the present invention is not limited to this case, but can be applied to the case that the EGR pipe 33 is heated by conducted heat or radiation heat from the exhaust manifold 12a.

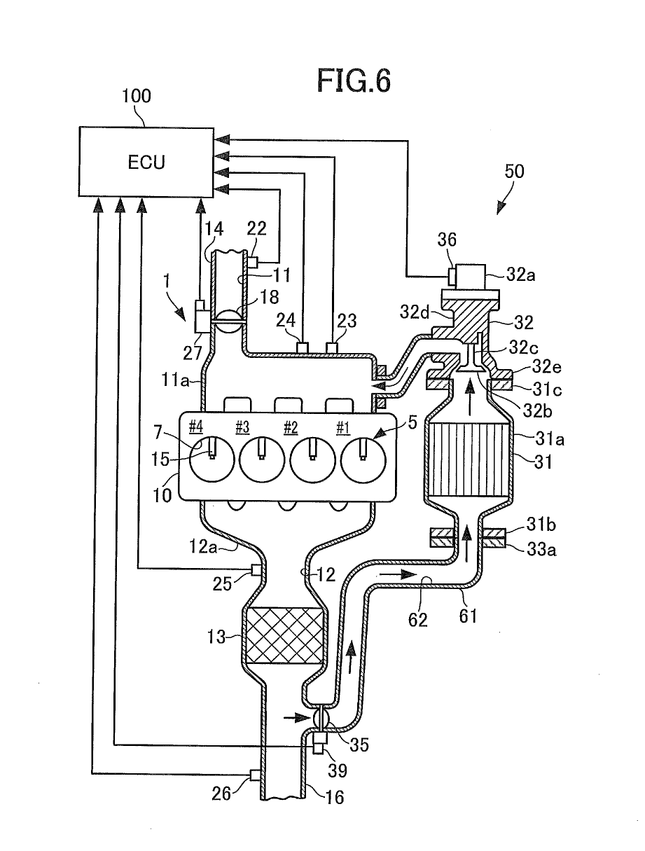

The exhaust gas recirculation apparatus of the internal combustion engine according to the second embodiment of the second embodiment will be described hereinafter with reference to FIG. 6.

The exhaust gas recirculation apparatus according to the second embodiment will be explained hereinafter with the constitution parts and elements forming the second embodiment bearing the same reference numerals as those of the first embodiment, and will be explained especially only about the different aspects in detail hereinafter.

The EGR device 50 according to the present embodiment comprises an EGR pipe 61 positioned at the upstream side of the EGR cooler 31 and disposed in the vicinity of the exhaust manifold 12a. The distance between the EGR pipe 61 and the exhaust manifold 12a is set so as to have the radiation heat of the exhaust manifold 12a reach the EGR pipe 61 and enabled to heat the EGR pipe 61 during the warm-up time of the engine. The exhaust manifold 12a in the present embodiment constitutes the heating unit defined in the present invention.

By the construction mentioned previously, the EGR pipe 61 can be heated by the radiation heat of the exhaust manifold 12a even when the EGR shutoff valve 35 comes to be fully closed to have the high temperature exhaust gas not flow into the EGR passage 62 formed in the EGR pipe 61. The temperature of the exhaust gas is higher than the dew point temperature, thereby making it possible to suppress the condensed water from being generated when the warm-up operation of the engine 1 is finished and the EGR shutoff valve 35 is transferred to the fully opened state.

Here, the vicinity of the upstream side end of the EGR pipe 61 is heated by the high temperature exhaust gas passing through the exhaust passage 12 in the same manner as that of the EGR device 30 according the first embodiment. This means that the EGR pipe 61 is required to have its portion low in effectiveness by the exhaust gas disposed to the vicinity of the exhaust manifold 12a.

The EGR pipe 61 may be heated by the conduction heat from the exhaust manifold 12a in lieu of the radiation heat by the exhaust manifold 12a. In the case that the EGR pipe 61 is heated by the conduction heat from the exhaust manifold 12a, the EGR pipe 61 at the upstream side of the EGR cooler 31 is shorter than the conventional EGR pipe to enable the whole part of the EGR pipe 61 position at the upstream side of the EGR cooler 31 to be heated by the conduction heat. The EGR pipe 61 may be heated by the radiation heat and the conduction heat of the exhaust manifold 12a.

As will be understood from the foregoing description, the exhaust gas recirculation apparatus of the internal combustion engine according to the second embodiment of the present invention, the EGR pipe 33 can be heated by the radiation heat and the conduction heat of the exhaust manifold 12a, and thus cost reduction can be realized by the exhaust gas recirculation apparatus simple in construction.

Although the above explanation has been made to the case that the EGR devices 30, 50 are applied to the engine 1 not provided with turbo unit, the present invention is not limited to this case, but may be applied to the case that the EGR devices 30, 50 are applied to the engine 1 provided with a turbo unit.

In this case, the EGR devices 30, 50 may be constructed by what is called a high-pressure loop, “HPL” in which the exhaust gas is acquired from the upstream side of the turbine wheel and then circulated as an EGR gas to the downstream side of the compressor wheel. Further, the EGR devices 30, 50 may be constructed by what is called a low-pressure loop, “LPL” in which the exhaust gas is acquired from the downstream side of the turbine wheel and then circulated as an EGR gas to the upstream side of the compressor wheel.

Though the explanation has been made about the case that the EGR pipes 33, 61 are bifurcated from the exhaust gas pipe 16 at the downstream side of the catalyst device 13, the present invention is not limited to this case, but may be applied to the case that the EGR pipes 33, 61 are bifurcated from the exhaust gas pipe 16 at the upstream side of the catalyst device 13 or from the exhaust manifold 12a. For the case that the EGR pipe 33, 61 are bifurcated from the exhaust manifold 12a, the EGR pipe 33, 61 may be integrally formed with the exhaust manifold 12a, or otherwise the EGR pipe 33, 61 and the exhaust manifold 12a may be connected with each other by a flange and the like for use in achieving hermetical seal therebetween.

Further, the above explanation has been made about the case that the EGR cooler 31 and the EGR valve 32 are formed by separate parts, however, the EGR cooler 31 and the EGR valve 32 may be accommodated in only one case according to the present invention.

Although the above explanation has been made about the case that the EGR devices 30, 50 are applied to the vehicle with the engine 1 mounted thereon and constructed by a gasoline engine, the present invention is not limited to this case, but the EGR devices 30, 50 may be mounted on the vehicle with the internal combustion engine such as a diesel engine and the like according to the present invention.

While there has been described about the case that the EGR devices 30, 50 are applied to a port injection type of engine which is adapted to inject the fuel to intake ports, the present invention is not limited to this case, but the EGR devices 30, 50 may be applied to a cylinder injection type of engine which is adapted to inject the fuel directly to each of the combustion chambers 7. The EGR devices 30, 50 may be applied to the engine which can perform both of the port injection and the cylinder injection.

The EGR devices 30, 50 may be applied not only to the vehicle powered only by the engine 1 previously mentioned but also to a hybrid vehicle powered by an engine and a rotating electric motor.

From the foregoing description, it will be understood that the exhaust gas recirculation apparatus according to the present invention can suppress the condensed water from being generated in the EGR pipe at the upstream side of the EGR cooler, and thus can suppress the EGR pipe from be corroded. As a consequence, the exhaust gas recirculation apparatus according to the present invention is useful as an exhaust gas recirculation apparatus.

### REFERENCE SIGNS LIST

1: engine
5: cylinder
7: combustion chamber
11: intake passage
11a: intake manifold
12: exhaust passage
12a: exhaust manifold
13: catalyst device
16: exhaust pipe
18: throttle valve
21: cooling water temperature sensor
22: air flow meter
23: intake air temperature sensor
24: pressure sensor
26: exhaust gas temperature sensor
30: EGR device
31: EGR cooler
32: EGR valve
32a: linear solenoid (EGR valve driving unit)
33: EGR pipe
34: EGR passage
35: EGR shutoff valve
36: valve opening sensor
37: engine rotation number sensor
38: outside air temperature sensor
39: shutoff valve opening degree sensor
40: cooling water circuit
45: heating pipe
46: cooling water passage
50: EGR device
61: EGR pipe
100: ECU

1. An exhaust gas recirculation apparatus of an internal combustion engine for recirculating part of exhaust gas discharged into an exhaust passage from an internal combustion engine to an intake passage as an EGR gas,
an EGR pipe formed therein with an EGR passage held in communication with the exhaust passage and the intake passage,
a first valve provided in the EGR pipe in the vicinity of the exhaust passage and operative to take an opened state and a closed state, the first valve being operative to shut off the EGR gas from being flowing into the EGR passage when the first valve takes the closed state,
a second valve provided in the EGR pipe at a position closer to the intake passage than the first valve and operative to take an opened state and a closed state to adjust the amount of the EGR gas flow into the intake passage,
an EGR cooler provided in the EGR pipe between the first valve and the second valve to cool the EGR gas flowing into the EGR passage, and a heating unit for heating the EGR pipe from the first valve to the EGR cooler.

2. The exhaust gas recirculation apparatus of the internal combustion engine as set forth in claim 1, in which the heating unit is adapted to heat the EGR pipe by the heat exchange with the cooling water of the internal combustion engine.

3. The exhaust gas recirculation apparatus of the internal combustion engine as set forth in claim 1, in which the heating unit is disposed outside of the EGR pipe to have the heating unit and the EGR pipe be in the form of a double pipe structure.

4. The exhaust gas recirculation apparatus of the internal combustion engine as set forth in claim 1, which further comprises a water temperature sensor for detecting the temperature of the cooling water of the internal combustion engine, and a control unit for controlling the first valve to have the first valve changed to take the opened state from the closed state, and for controlling the opening degree of the second valve when the temperature of the cooling water detected by the water temperature sensor is not lower than a threshold value.

5. The exhaust gas recirculation apparatus of the internal combustion engine as set forth in claim 4, which further comprises an outside air temperature sensor for detecting an outside air temperature, and in which the control unit is adapted to set the threshold value in response to the outside air temperature detected by the outside air temperature sensor.

6. The exhaust gas recirculation apparatus of the internal combustion engine as set forth in claim 1, in which the heating unit is constituted by an exhaust manifold for introducing the exhaust gas from the internal combustion engine to the exhaust passage, and the EGR pipe is heated by radiation heat from the heating unit.

7. The exhaust gas recirculation apparatus of the internal combustion engine as set forth in claim 2, in which the heating unit is disposed outside of the EGR pipe to have the heating unit and the EGR pipe be in the form of a double pipe structure.

8. The exhaust gas recirculation apparatus of the internal combustion engine as set forth in claim 7, which further comprises a water temperature sensor for detecting the temperature of the cooling water of the internal combustion engine, and a control unit for controlling the first valve to have the first valve changed to take the opened state from the closed state, and for controlling the opening degree of the second valve when the temperature of the cooling water detected by the water temperature sensor is not lower than a threshold value.

9. The exhaust gas recirculation apparatus of the internal combustion engine as set forth in claim 8, which further comprises an outside air temperature sensor for detecting an outside air temperature, and in which the control unit is adapted to set the threshold value in response to the outside air temperature detected by the outside air temperature sensor.
